(19) United States
(12) Patent Application Publication
(10) Pub. No.: US 2007/0096456 A1
(43) Pub. Date: May 3, 2007

(54) Folders with Entertainment Functionality

(76) Inventor: Robert Silverman, Long Beach, CA (US)

Correspondence Address: PATENTMETRIX, 14252 CULVER DR. BOX 914, IRVINE, CA, 92604, US

(21) Appl. No.: 11/534,449

(22) Filed: Sep. 22, 2006

Related U.S. Application Data
(60) Provisional application No. 60/720,137, filed on Sep. 23, 2005.

(51) Int. Cl. B42D 3/18

(52) U.S. Cl. 281/51

(57) ABSTRACT

The present invention is directed toward a folder having at least one pocket with entertainment functionality. The outer and inner sides of the front, back and/or divider panels serve as display layers comprising a variety of interactive audio/visual stimuli enabling elements such as picture graphics, illuminated picture sections and/or sound recording or playing systems.

### CROSS-REFERENCE TO RELATED APPLICATIONS

The present invention relies on, for priority, U.S. Provisional Application No. 60/720,137, entitled “Binders with Advanced Entertainment Functionality”, filed on Sep. 23, 2005.

### FIELD OF THE INVENTION

The present invention relates generally to folders, such as those two-pocket folders used by students, and more specifically to a folder having at least one pocket that allows for a plurality of audio and/or visual entertainment features to be presented on the cover and/or on the inside flaps of the folder.

### BACKGROUND OF THE INVENTION

Folders designed to contain and organize documents, such as 8.5×11 inch paper, are used by students in the educational sector. The folders vary in design depending on their intended purpose. They can have varied materials for the front and back covers, contain a plurality of flaps or dividers between the front and back covers, contain a single pocket on a flap or divider, contain multiple pockets on a flap or divider, contain internal paper holding devices, such as rings, clips, or other binding mechanisms, and include various types of colors, art work, or other designs.

Folders, which have at least one pocket and are designed for students in the education sector, tend to be made of flexible thick stock cardboard or plastic, are capable of being “three-hole punched”, and are frequently multi-colored or inclusive of entertaining artwork or logos. To date, these pocket folders have not, however, included more advanced entertainment functionality, such as music, lights, motion, or other interactive visual or auditory displays.

It would be desirable to have a folder with at least one pocket that can provide advanced entertainment functionality, such as music, lights, motion, or other interactive visual or auditory displays, while still imparting all of the conventional functionality of a folder. It would further be desirable for the folder to be useful in an educational setting and not be disruptive or intrusive thereof. It would additionally be desirable for the folder with advanced entertainment functionality to be sufficiently rugged and durable to withstand conventional uses in the educational field.

U.S. design Pat. No. D282,377, depicts a conventional folder, which has a front cover, back cover and no pockets, in association with a small clock and memo pad. The clock is shown as a single unit that is affixed to the folder surface, with the clock's operative circuitry not integrated into the folder itself. U.S. Pat. No. 5,063,698 discloses a personalized greeting card that includes an independent, detachable, electronic memory device, which stores electronic signals, a mechanism for retrieving the electronic signals from the memory device, a voice synthesizer which obtains these electronic signals and produces audible sounds representative of the personalized message, and a switch that controls the retrieving device and the voice synthesizer.

Other U.S. patents, such as U.S. Pat. No. 3,462,157, have similarly disclosed the incorporation of audio messaging circuitry in a greeting card. For example, U.S. Pat. No. 4,791,741 discloses a card, such as a greeting card, which comprises a storage member to retain audio information picked up by a microphone, a sound generating member including a speaker, a mode selection signal producing member to allow either record or playback to be selected, a controller performing record or playback according to the mode selection signal from the mode selection signal member, and a card board on which the microphone, speaker, and other members are mounted.

### SUMMARY OF THE INVENTION

The present invention is directed toward a folder, having at least one pocket, with advanced entertainment functionality. The outer and inner sides of the front, back and/or divider panels serve as display layers comprising a variety of interactive audio/visual stimuli enabling elements such as mechanically driven moving parts, picture graphics, illuminated or luminescent picture sections and/or sound recording/playing systems.

In one embodiment, the folder assembly, having at least one pocket, comprises a first cover having a front panel and a back panel and a second cover having a front panel and a back panel wherein the second cover is physically attached to the first cover. A display layer is physically incorporated into the front panel of the first cover wherein the display layer has embedded therein an activation button and a plurality of LEDs. Circuitry is contained within at least one of the first or second cover. The circuitry places in electrical communication a power source, the activation button and the LEDs. A substrate, which is part of at least one of the first or second cover, is in physical contact with the circuitry for providing protection to the circuitry. The LEDs can flash randomly or in a predetermined pattern.

In another embodiment, the folder assembly, having at least one pocket, comprises a first cover having a front panel and a back panel, and a second cover having a front panel and a back panel wherein the second cover is physically attached to the first cover. A display layer is physically incorporated into the front panel of the first cover wherein the display layer has embedded therein an activation mechanism and a speaker. Circuitry is contained within at least one of the first or second cover. The circuitry places in electrical communication a power source, a memory, the activation mechanism and the speaker. A substrate, which is part of at least one of the first or second cover, is in physical contact with the circuitry and provides protection to the circuitry. The activation mechanism is in the form of a display layer having a graphical image of a piano key, in the form of strings protruding from the surface of the display layer, in the form of a display layer having a graphical image of a drumstick, or in the form of a display layer having a graphical image of a drum. The activation mechanism may be in the form of a display layer having a graphical image of any instrument.

In one embodiment, the folder assembly, having at least one pocket, comprises a first cover having a front panel and a back panel, and a second cover having a front panel and a back panel wherein the second cover is physically attached to the first cover. A display layer is physically incorporated into the front panel of the first cover wherein the display layer has embedded therein an activation mechanism and a plurality of gears. Protruding from the display layer is any movable structure, such as a wheel, the hands of a clock, or a cardboard surface with an ornamental design. Circuitry is contained within at least one of the first or second cover. The circuitry places in electrical communication a power source, the activation mechanism and the plurality of gears. A substrate, which is part of least one of the first or second cover, is in physical contact with the circuitry for providing protection to the circuitry. It should be appreciated, again, that the movable structure can be any image, including a rotating wheel, a rotating disc, a moving set of hands positioned within the face of a clock, or a rotating image or logo.

In one embodiment the front, back and divider panels, one of which has at least one pocket, are composite layered structures. At the core of the structure is a substrate of a flexible yet sturdy material such as Mylar, cardboard or any other suitable material, followed by a second layer of activation switches and audio/visual stimuli generating elements such as electro-luminescent (EL) lamps, a speaker and/or a microphone device. Finally, a display layer of a suitable material such as plastic covers the second layer.

The display layer can be printed with a plurality of scenes or graphics and/or textual characters for visual display. The display layer can also be printed with activation regions that, when pressed by a user, result in the activation of membrane switches causing an underlying circuit to close. This results in the activation of specific EL lamps and/or speaker/microphone for illumination of required areas/spots on the display layer and/or for audio playback or recording purposes. Alternate embodiments may include on/off buttons that are interspersed on the display layer and that can be pressed by a user for activation of audio/visual effects.

In one embodiment the activation switches are coupled to a Printed Circuit Board (PCB) via traces and/or electrical contacts. Sound generators (such as digital sound cards), electronic memory (such as PROM, ROM, EEPROM, etc.) and sequencing circuits are also disposed on the PCB and may take the form of an integrated circuit coupled to a speaker and/or a microphone. A suitable power source, such as at least one battery, is provided to power the entire circuit arrangement. A power button is coupled to the power source to selectively actuate the interactive circuit.

The interactive and entertainment features of the present invention are described using a plurality of embodiments of the display layer. For example, the display layer can include the form of a fortuneteller silhouette, an illumination of textual portions (“Hot”), a presentation of audio wherein voice messages can be recorded and/or played when required by a user, an interactive musical instrument such as a guitar on the display layer that forms the inside surface of the front and back panels of the folder unit, a raised movable structure on a surface of the display layer of the divider panel or a back-illuminated picture on the display layer of the divider panel.

### BRIEF DESCRIPTION OF THE DRAWINGS

These and other features and advantages of the present invention will be further appreciated, as they become better understood by reference to the following Detailed Description when considered in connection with the accompanying drawings:

FIG. 1 depicts one embodiment of a folder assembly;

FIG. 2A is a side view showing a power switch having its contacts separated by means of an insulating tab that is inserted into the switch contacts when the front over is closed;

FIG. 2B is a side view showing the insulating tab of FIG. 2A extracted, that occurs when the front cover is open which then allows the switch contacts to make contact;

FIG. 3 depicts another embodiment of a folder assembly;

FIG. 4A is a cross sectional schematic view of one embodiment of a composite structure of the cover and/or divider panel;

FIG. 4B is a cross sectional schematic view of one embodiment of a composite structure of the cover and/or divider panel;

FIG. 5A is an electrical wiring diagram of one embodiment of the present invention wherein the folders include light emitting elements;

FIG. 5B is another electrical wiring diagram of one embodiment of the present invention wherein the folders include light emitting elements;

FIG. 5C is a graphical representation of one display layer of the present invention wherein the folders include light emitting elements;

FIG. 5D is another graphical representation of a display layer of the present invention wherein the folders include light emitting elements;

FIG. 6A is an electrical wiring diagram of one embodiment of the present invention wherein the folders include a movable structure;

FIG. 6B is a graphical representation of one display layer of the present invention wherein the folders include a movable structure;

FIG. 6C is a graphical representation of another display layer of the present invention wherein the folders include a movable structure;

FIG. 6D is a side planar view of the display layer of the present invention wherein the folders include a movable structure elevated from the display layer surface;

FIG. 7A is one embodiment of the display layer on the outside of the cover of the folder unit for an interactive musical folder;

FIG. 7B is a bottom plan view of an interactive musical folder showing the relative location of a front cover consisting of two panels and a back cover also consisting two panels;

FIG. 7C is an electrical wiring diagram of an interactive musical folder's electronics circuit;

FIG. 7D is a front elevational view of the front cover's inner panel having a set of four elongated slots through which project a set of finger-activated electrical contacts;

FIG. 7E is a front elevational view of the front cover's inner panel having a set of four circular openings through which project a set of finger-activated electrical contacts;

FIG. 7F is another schematic diagram of an interactive musical folder's electronics circuit;

FIG. 8A is an electrical wiring diagram of one embodiment of the present invention wherein the folders include a back-illuminated design;

FIG. 8B is a graphical representation of one display layer of the present invention wherein the folders include a back-illuminated design;

FIG. 9A is an electrical wiring diagram of one embodiment of the present invention wherein the folders include audio recording and playback capabilities; and

FIG. 9B is a graphical representation of one display layer of the present invention wherein the folders include audio recording and playback capabilities.

### DETAILED DESCRIPTION OF THE DRAWINGS

The present invention is directed toward a folder with at least one pocket with entertainment functionality. Various modifications to the disclosed embodiments will be readily apparent to those of ordinary skill in the art, and the disclosure set forth herein may be applicable to other embodiments and applications without departing from the spirit and scope of the present invention and the claims hereto appended. Thus, the present invention is not intended to be limited to the embodiments described, but is to be accorded the broadest scope consistent with the disclosure set forth herein. Further, whenever the term “present invention” is used in association with a particular feature, it should be appreciated that the feature is only being described with respect to one, of several, embodiments of the invention and should not be considered a requirement of all embodiments of the invention.

### GENERAL PHYSICAL STRUCTURE OF EXEMPLARY FOLDERS

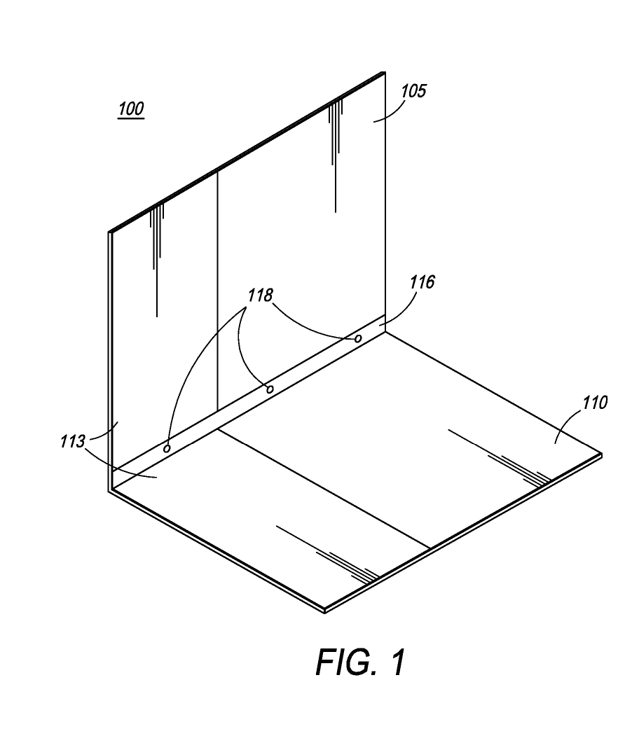

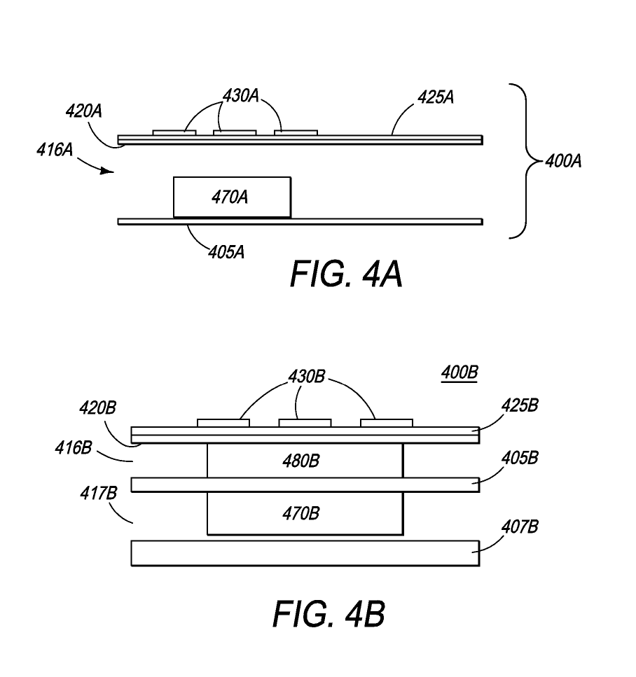

Referring to FIG. 1, a document folder assembly 100, having at least one pocket, according to one embodiment of the present invention is shown. The folder unit 100 has a front cover portion 105, a back cover portion 110, a hinge portion 116 for hinging together adjacent longitudinal edge sections of the front and back panel portions 105, 110, and pockets 113 within which documents can be placed. Both the front cover portion 105 and back cover portion 110 comprise inner and outer panels which face inward to each other and outward to the environment, respectively. The folder assembly 100 is preferably made of materials that can be “3 hole punched” using a conventional hole puncher. Specifically, it is preferable that the folder 100 comprise flexible thick stock cardboard. It is further preferable that the folder 100 comprise markings 118 that indicate where a three hole punch device should be aligned in order to properly create a 3 hole punched folder. Structurally, the front cover portion 105 and back cover portion 110 are composite structures that comprise of a plurality of layers, as shown in FIGS. 4A and 4B, which depicts one embodiment of the layers of the front cover and back cover portion.

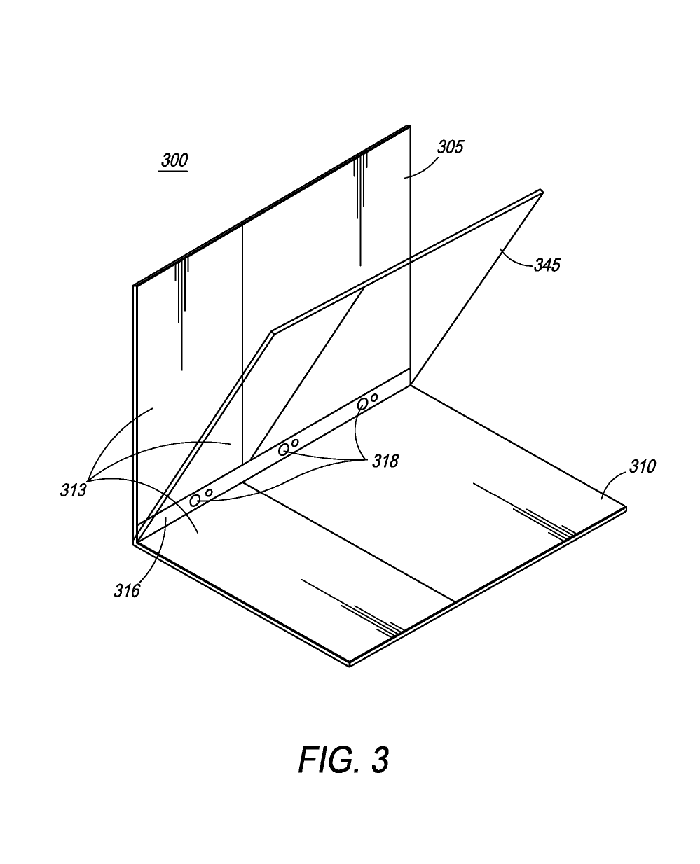

Another embodiment of the folder unit 300, shown in FIG. 3, comprises a divider panel 345. The folder unit 300 has a protective front cover portion 305, a back cover portion 310, a hinge portion 316 for hinging together adjacent longitudinal edge sections of the front and back panel portions 305, 310, and pockets 313 within which documents can be placed. The pockets 313 may be placed on the inside of the front panel portion 305, the inside of the back panel portion 310, and/or on either side of the divider panel 345. Both the front cover portion 305 and back cover portion 310 comprise inner and outer panels which face inward to each other and outward to the environment, respectively. Similarly, the folder assembly 300 is preferably made of materials, such as flexible thick stock cardboard, that can be “3 hole punched” using a conventional hole puncher. It is further preferable that the folder 300 comprise markings 318 that indicate where a three hole punch device should be aligned in order to properly create a 3 hole punched folder. Structurally, the front cover portion 305 divider portion 345, and/or back cover portion 310 are composite structures that comprise of a plurality of layers, as shown in FIGS. 4A and 4B, which depicts one embodiment of the layers of the front cover, divider panel, and back cover portion.

The exemplary folder embodiments, described above, comprise covers, including a front panel, back panel, and/or divider panel, that are composite structures. The composite structures comprise of a plurality of layers. FIG. 4A shows one embodiment of a portion of the composite structure of the front cover, back cover, and/or the divider panel. As shown, the composite structure 400A comprises a) a support substrate 405A, b) a layer 416A within which mechanisms supporting any audio, visual, or interactive features and circuitry for enabling such features 470A are housed, as further detailed below, c) a plurality of interactive or audio/visual features 430A, such as activation switches, embedded within a protective layer 420A, and d) a display layer 425A having ornamental designs. The display layer 425A contains spaces through which interactive or audio/visual features 430A can be accessed by a user. The display layer 425A includes graphic designs and other visual elements. The display layer 425A further comprises flexible thick stock cardboard and may include other materials such as non-porous, flexible polymer substrate materials such as Mylar, paper, fabric or any other suitable material known to persons of ordinary skill in the art. The aforementioned layered structure of the front cover, back cover, and/or the divider panel of the folder unit allows for distinct displays containing advanced entertainment functionality. It should be appreciated that the display layer 425A can face to the external environment or face internally toward a front cover, back cover, or divider panel.

The support substrate 405A and protective layer 420A are protective structures that provide further protection to the electronics 470A in layer 416A. The support substrate 405A and protective layer 420A are preferably made of plastic or cardboard that, while flexible, are not readily punctured. Because the folder is preferably designed to be “3 hole punched”, it is preferable that the substrate 405A and/or protective layer 420A include carve outs, made in alignment with the three hole punch markings on the folder, such that, when a three hole punch in the folder is made, it punctures through the carve-outs and avoid the substrate 405A and protective layer 420A altogether. The substrate 405A and/or protective layer 420A can either be a layer physically bonded to the display layer or it can be a removable insert that, together with the electronics layer, is inserted into the cover or divider.

FIG. 4B shows another embodiment of a portion of the composite structure of the front cover, back cover, and/or the divider panel. As shown, the composite structure 400B comprises a) a first support substrate 405B, b) a second support substrate 407B, c) a layer 416B within which mechanisms supporting any audio, visual, or interactive features 480B are housed, d) a layer 417B within which circuitry enabling such mechanisms 470B are housed, e) a plurality of interactive or audio/visual features 430, such as activation switches, embedded within a protective layer 420, and f) a display layer 425. As in FIG. 4A, the display layer 425 contains spaces through which interactive or audio/visual features 430 can be accessed by a user and includes graphic designs and other visual elements.

The first support substrate 405B, second support substrate 407B, and protective layer 420B are protective structures that provide further protection to the mechanisms 480B and electronics 470B in layers 416B and 417B, respectively. The two support substrates 405B, 407B and protective layer 420B are preferably made of plastic or cardboard that, while flexible, are not readily punctured. Because the folder is preferably designed to be “3 hole punched”, it is preferable that the substrates 407B, 405B and/or protective layer 420B include carve outs, made in alignment with the three hole punch markings on the folder, such that, when a three hole punch in the folder is made, it punctures through the carve-outs and avoid the substrates 407B, 405B and protective layer 420B altogether.

### EXEMPLARY ACTIVATION MECHANISM

The interactive, audio, or visual features of the folders of the present invention can be activated by a user pressing, pushing, pulling, or otherwise exerting force on a structure, such as a button or lever, as further discussed below in relation to each specific embodiment. Alternatively, the interactive, audio, or visual features of the folders of the present invention can be automatically activated when a user opens or closes the front cover, back cover, or divider panel of the folder.

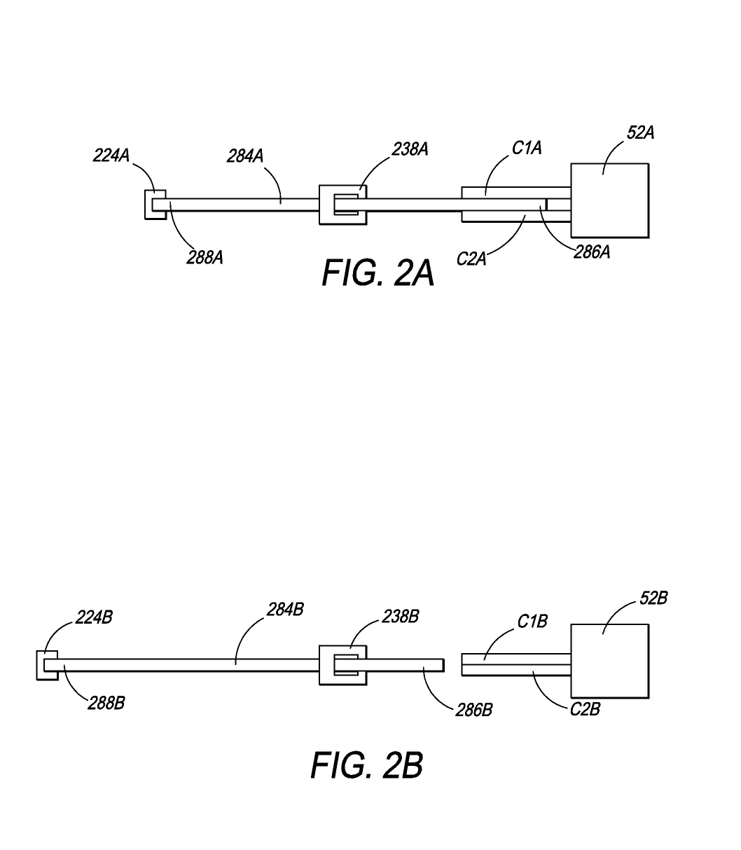

Referring to FIG. 2A, one optional element that can be included in the electronics circuitry of the present invention is a power switch 52A. This switch 52A is comprised of a normally-closed, leaf spring switch having a first leaf contact (C1A) and a second leaf contact (C2A). The switch 52A is activated by means of an insulating tab 284A having an inner section 286A and an outer section 288A. The outer section 288A is inserted through the switch slot 238A and attached adjacent the inner edge 224A of the front cover [not shown]. The inner section 286A is inserted between the first leaf contact C1A and the second leaf contact C2A of the switch 52A. The insulating tab 284A is automatically inserted into the contacts when the front cover [not shown] is closed against the back cover [not shown]. Conversely, referring to FIG. 2B, when the front cover [not shown] is opened, the insulating tab 284B is extracted from the switch contacts C1B, C2B, allowing the two switch contacts C1B, C2B to close and enable the circuitry [not shown]. One of ordinary skill in the art would appreciate that other mechanisms of enabling or disabling power to electronic circuitry can be used.

Folder With Light Emitting Elements

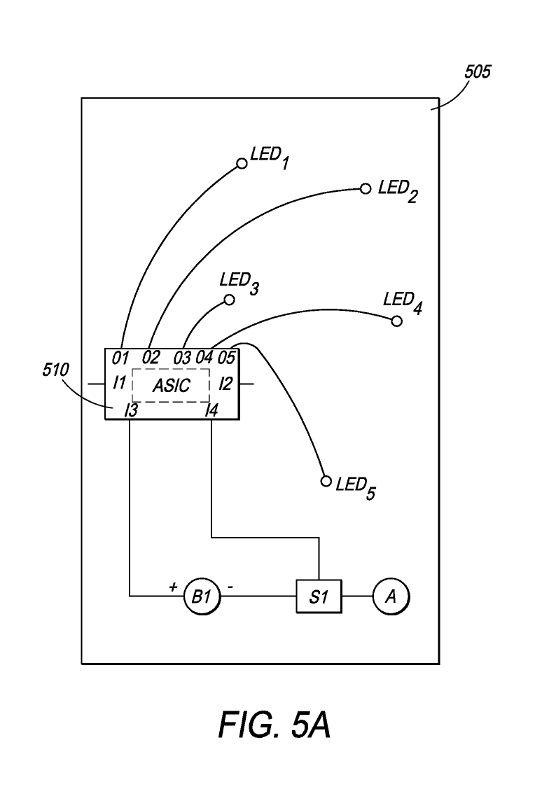

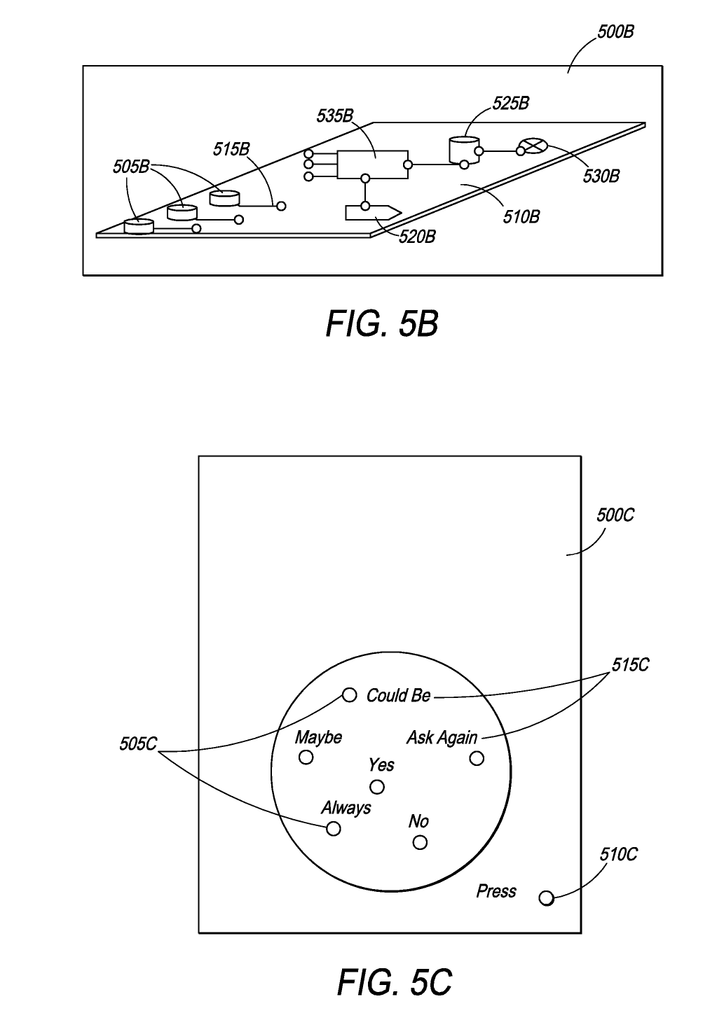

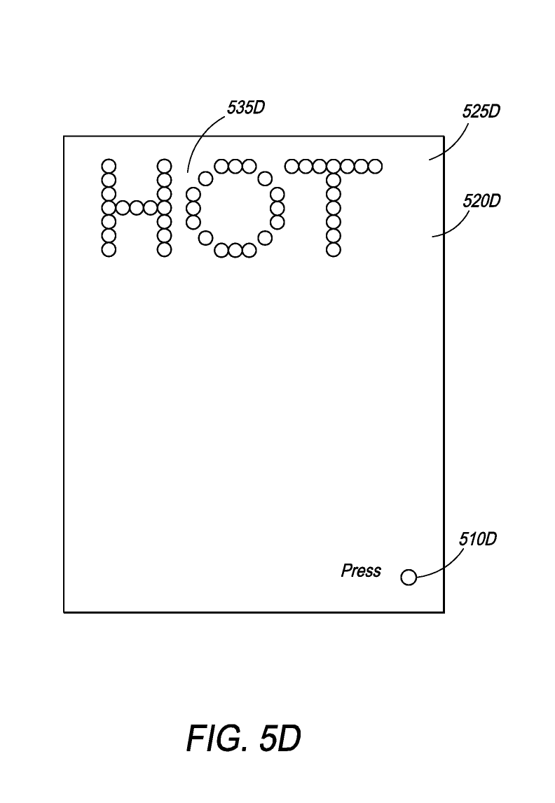

Referring to FIG. 5A, electronic circuitry and interactive and visual features defining one embodiment of the present invention are shown. In this exemplary embodiment, a plurality of electronics is provided in at least one of the front cover, back cover or divider panel 505A. The plurality of electronics are embedded in a layer within the front cover, back cover, or divider cover, as in layer 416A of FIG. 4A or layers 416B or 417B of FIG. 4B.

The electronics circuit is comprised of an integrated circuit (IC) 510, a set of light emitting diodes (LED₁-LED₅), a battery (B1), a power switch (S1), and an activation mechanism (A), such as a button, that provides the electrical contact to thereby switch the power on. The IC 510 is comprised of an Application Specific Integrated Circuit (ASIC). The ASIC can be programmed to randomly select one or more light emitting diodes (LED₁-LED₅) to transmit a power signal to in order to cause to the diode to light up. The ASIC has a first input (I), a second input (I2), a third input (I3), a fourth input (I4), and a plurality of outputs, 1-5, to the plurality of light emitting diodes (LED₁-LED₅). Operationally, when a user activates the activation button A, it causes the switch S1 to transmit power, originating from the battery B1, to the ASIC which, in turn, is programmed to cause any one or more of the LEDs to light up using any random or organized pattern. The battery B1 is preferably a button-type battery and may consist of a set of batteries connected in series to provide the required voltage to operate the ASIC.

FIG. 5B shows a schematic diagram depicting another exemplary circuit 500B enabling entertainment functionality. The exemplary circuit 500B is typically incorporated into an electronics layer in a composite layer, shown as 416A in FIGS. 4A and 416B, 417B in FIG. 4B. A plurality of light emitting elements, such as LEDs, or electroluminescent (EL) lamps 505B is coupled to a thin printed circuit board (PCB) 510B via traces 515B. A combination of an electronic memory and sequencing circuit is disposed on the PCB 510B and may take the form of an integrated circuit 535B. Optionally, an audio source or microphone 620 can be in electrical communication with the integrated circuit 535B. A suitable power source, such as batteries 525B, is provided to power the circuit 500. An activation button or power button 530B is coupled to the power source to selectively activate the interactive circuit 500B.

The EL lamps of the present invention are preferably discrete cells that are situated close to the display layer for maximum brightness of the overlying graphical and/or textual characters. The EL lamp layer is a typical EL polymer thick film with a top electrically conductive and light-transmissive ink pattern serving as a top electrode and a bottom electrically conductive ink pattern serving as a bottom electrode. Other types of EL lamps comprise those utilizing foil electrodes or phosphor-impregnated resins or any other suitable type well known in the art. Also, although the EL lamps have been described above as being incorporated in a layer, it should be evident to persons of ordinary skill in the art that the present invention may be practiced with the EL lamps being “printed” directly on the inner surface of display layer.

Activation of the LEDs or EL lamps is caused by manually pressing a switch/button such as an on/off switch 510C, as designated in FIG. 5C by the text “Press”. One embodiment comprises membrane switches interspersed suitably within the graphic pattern of the display layer itself. A membrane switch may cause activation of a series of EL lamps in a random raster fashion such as when illuminating all the areas 505C one by one in a random fashion.

An activation switch 510C may include double-pole type membrane switches comprising a top pair of parallel spiral conductive ink traces on a first surface, such as the inner surface of display layer, and a bottom pair of parallel spiral conductive ink traces on a second surface, such as the top surface of the substrate layer. The two sets of spirals are positioned to face each other, and are spaced apart with a suitable space of predetermined thickness. The display layer is printed with activation regions of the membrane switch(es) indicating where the user should depress the switch. When the activation region of a switch is depressed, top spiral set comes into contact with bottom spiral set thus activating the switch and closing a circuit. The layer of membrane switches that contains the top set of spirals and the activation regions are preferably made of flexible material such that depression of activation region causes sufficient deflection of those layers to allow contact of the top and bottom sets of spirals. A material such as Mylar offering flexibility for light-pressure touch activation and durability for use is preferred.

It is preferred that the activation of the advanced entertainment functionality be manual, such as through a depressable switch. While greeting cards provide some limited entertainment functionality through automatic activation, because the folders are used in a completely different environment, it is essential that the activation be controllable and not automatic whenever the folder is opened, although that is an option possible in embodiments of the present invention.

Referring to FIG. 5C, a fortune-teller graphical and textual pattern of the display layer is presented as one example according to the present invention. The panel 500C can be any of the outer panel of the front cover of a folder, the inner panel of the front cover of a folder, the outer panel of the back cover of a folder, the inner panel of the back cover of a folder, or an internal panel of a divider. On the surface of the panel are a series of textual statements 515C placed in physical proximity or association with LED or EL lamps 505C. An activation button 510C that, when pressed, initiates the excitation of the LEDs or EL lamps, is also provided. When excited, the LEDs, for example, flash either randomly or in a predetermined manner.

Operationally, it is intended that an individual “asks a question” to the fortune-teller, preferably graphically depicted on the panel 500C, presses the activation button 510C, watches the LEDs flash, and receives his or her answer to the question when the LEDs stops flashing and a single LED remains lit next to a particular text phrase 515C, i.e. “Could Be” or “Ask Again”. One of ordinary skill in the art would appreciate that another display having unique graphics, text, and LED or EL lamp patterns may be affixed to the back of the first fortuneteller display page with the LED or EL lamps facing inwardly and the corresponding display layer facing outwardly. One would further appreciate that the length of flashing, which LEDs flash, the colors of the LEDs, the pattern of LED placement on the panel, the pattern of flashing, the rate of flashing, the type of textual statements made, and how long the final LED is lit are all parameters which can be readily modified based on commercial or market needs. For example, the LEDs can flash for five seconds, ten seconds, twenty seconds, one minute, or indefinitely until a user presses a button, such as button 510C. The LEDs can flash in a particular pattern, such as clockwise, counterclockwise, from the middle outward, from the outer edges inward, or randomly.

Referring to the embodiment of FIG. 5C in the context of the composite structure 400B shown in FIG. 4B, in one embodiment, the display layer 425B comprises some translucent regions. A layer of LED or EL lamps underlies the display layer 425 with the individual LEDs or lamps positioned in a pattern corresponding to those portions of the graphics that are to be illuminated. For example, in the current embodiment of the fortuneteller graphics, one LED or EL lamp is positioned under each of the areas 505 of display layer 425B that are meant to glow to highlight any of the corresponding prediction texts 515C. The fortuneteller and text layout can be achieved by printing a positive silhouette, such as areas 505C, on the outer face of display layer 425B, and a negative silhouette with dark ink directly underneath the positive silhouette. This arrangement confines the illumination of the LED or EL lamp below a specific graphic and/or textual pattern that is required to be illuminated. The LEDs or EL lamps can be combined with the printing to achieve a variety of effects. For example, patterns and/or characters themselves may be illuminated or may be printed in dark ink and backlighted when an EL lamp illuminates the background. The display layer 425 may also contain non-activatable portions, which simply complete the illustrated scene. Any pattern created by lighting elements embedded within a folder cover or divider panel, having one or more pockets, is contemplated to be an embodiment of the present invention.

Referring to FIG. 5D, another embodiment of the display layer that forms the outer face of the cover of the folder unit is shown. Here the illumination through light emitting elements is not random—rather they are used to highlight a textual sign 535D (i.e., “HOT”) or display any other message when a user presses an activation switch via activation region 510D printed on the display layer 525D. One of ordinary skill in the art would appreciate that the ASIC [not shown] can be programmed to light the light emitting devices in accordance with any pattern.

Folder with a Movable Structure

Yet another embodiment of the present invention includes a display layer of the divider panel that incorporates a power source, gear, and movable structure physically attached to said gear, such as a rotating wheel or circular cardboard structure. The movable structure is physically attached to said gear and sufficiently elevated from the display layer such that, when an activation button is depressed, the power source provides motive force to the gear which, in turn, moves the movable structure. In one embodiment, the gear spins a cardboard wheel.

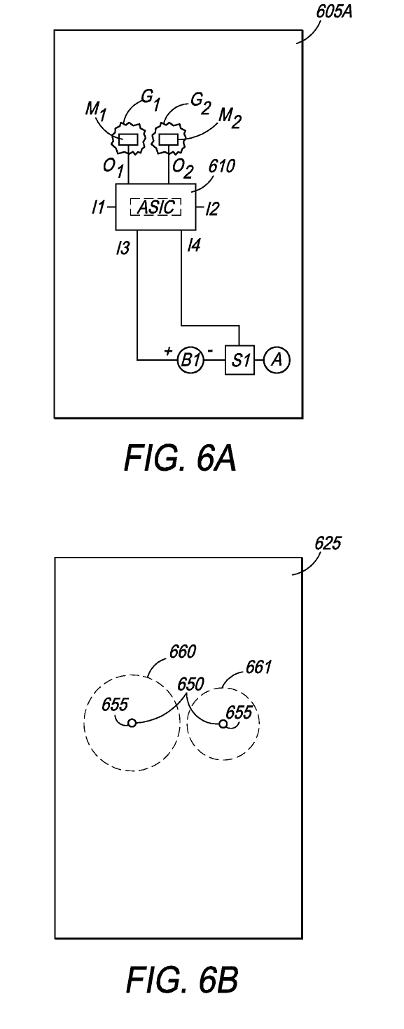

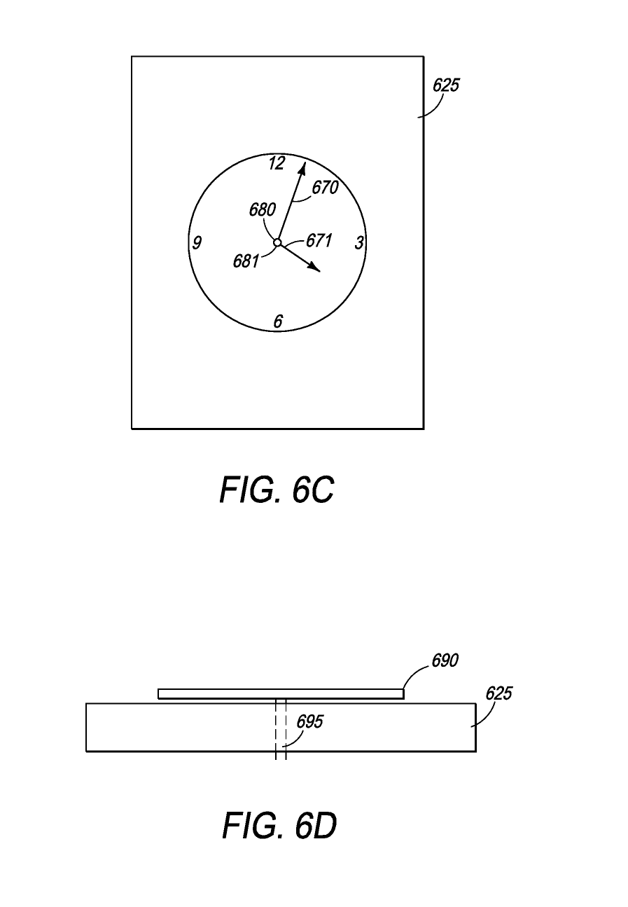

Referring to FIG. 6A, electronic circuitry and visual features defining one embodiment of the present invention are shown. In this exemplary embodiment, a plurality of electronics is provided in at least one of the front cover, back cover or divider panel 605A. The plurality of electronics are embedded in a layer within the front cover, back cover, or divider cover, as in layer 416A of FIG. 4A or layers 416B or 417B of FIG. 4B.

The electronics circuit is comprised of an integrated circuit (IC) 610, a plurality of gears (G₁-G₂) in combination with a motor (M₁-M₂), a battery (B1), a power switch (S1), and an activation mechanism (A), such as a button, that provides the electrical contact to thereby switch the power on. The IC 610 is comprised of an Application Specific Integrated Circuit (ASIC). The ASIC can be programmed to transmit signals that cause one or more of the motors, M₁-M₂, to apply motive force to the gear, G₁-G₂, to which it is physically attached. The ASIC has a first input (I1), a second input (I2), a third input (I3), a fourth input (I4), and a plurality of outputs, 1-2, to the plurality of motors, M₁-M₂. Operationally, when a user activates the activation button A, it causes the switch S1 to transmit power, originating from the battery B1, to the ASIC which, in turn, is programmed to cause any one or more of the motors, M₁-M₂, to apply motive force to the gears, G₁-G₂, in accordance with any random or organized pattern of movement. It should be appreciated that the motors could be used to apply motive force to any mechanical drive element, such as levers or pulleys, that can be used to move a structure elevated from the display layer. The battery B1 is preferably a button-type battery and may consist of a set of batteries connected in series to provide the required voltage to operate the ASIC.

Referring to FIG. 6B in the context of the composite structure 400B shown in FIG. 4B, the display layer 625 comprises an opening 650 through which at least one member 655, originating from at least one gear [not shown], extends out and above the display layer 625. The shaft 655 terminates in a structure 660, such as rotating wheel. As shown in FIG. 6B, each of the gears has a member 655, 656 that extends out and above the display layer 625 and terminates in a rotating wheel 660, 661. The structure 660 can be of any design, shape, configuration, or size that a) can be effectively moved by a gear/motor combination of sufficiently small size to be incorporated into a folder layer and b) will preferably not extend beyond the bounds of the folder front cover or back cover.

Referring to FIG. 6C, the structures 660, 661 are shown to be the hands 670, 671 of a clock. Here, the gears [not shown] rotate two members 680, 681 that extend above the display layer 625 and attach to arrows which function as the hands 670, 671 of a clock. The ASIC [not shown] is programmed to move the hands 670, 671 in accordance with an internal clock, thereby causing the gear driving the shaft 680 attached to the minute hand 670 to increment one minute unit every minute and causing the gear driving the shaft 681 attached to the hour hand 671 to increment one hour unit every hour. As shown in FIG. 6D, any structure 690 that is supposed to move is elevated above the display layer 625 and connected to a member 695 extending through the display layer 625.

Interactive Music Folder

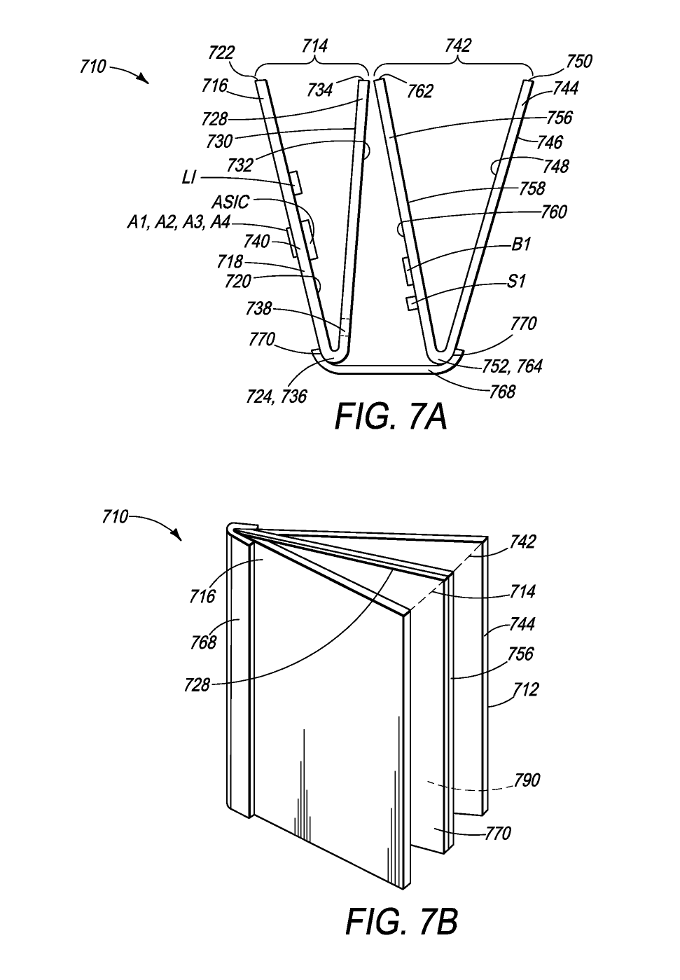

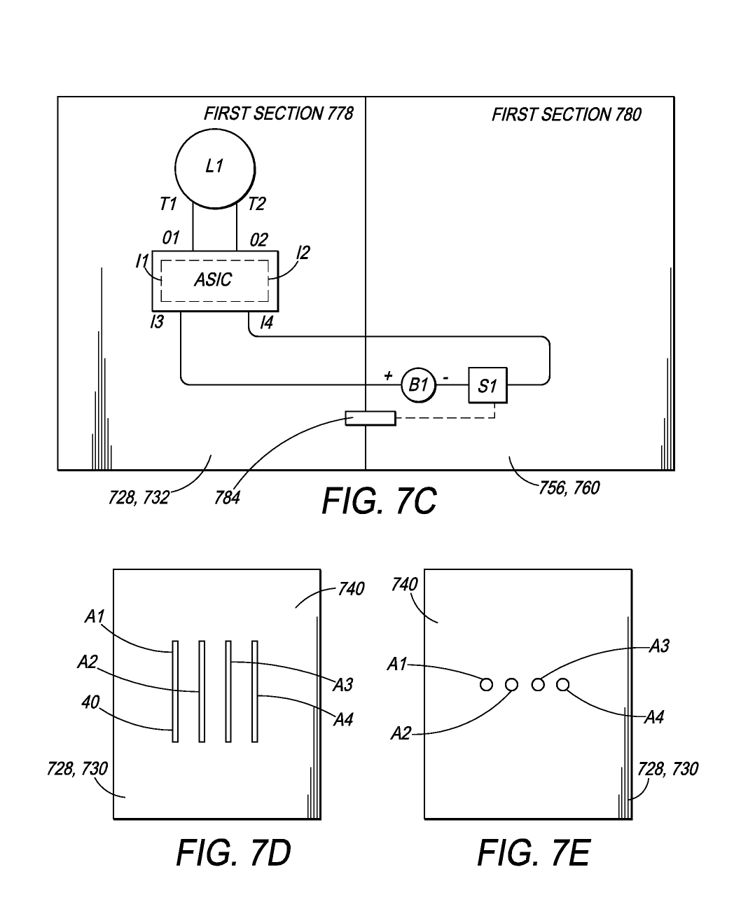

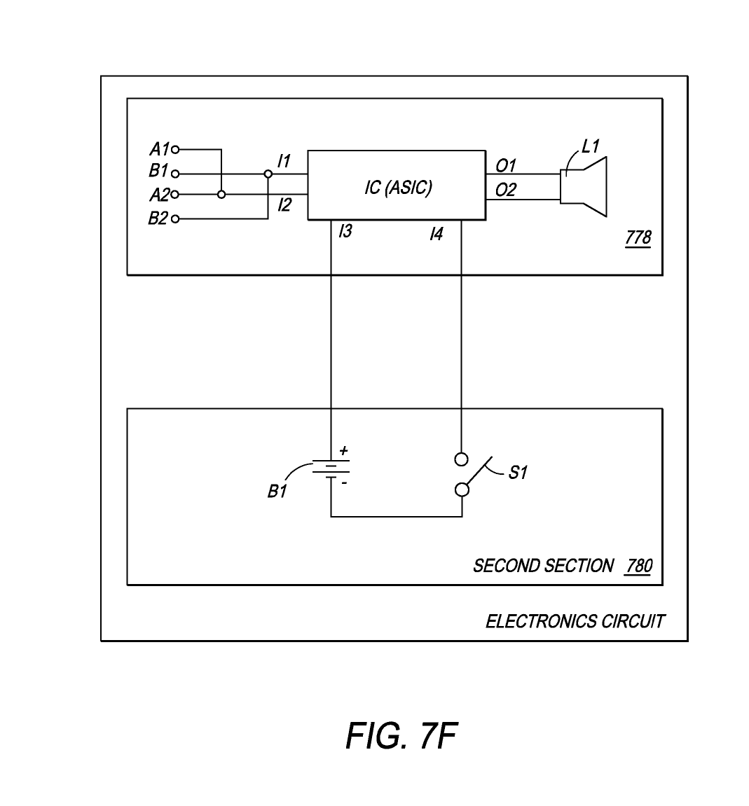

FIGS. 7A-7F show yet another embodiment of the display layer 425 that preferably forms the inner face of the cover of the folder unit or one of the surfaces of the divider panel. Because the entertaining audio/visual features of the present embodiment are provided on the inside of the folder these features can be more intricate with certain features protruding from the panel surface. Typically, protusions from the panel surface are avoided if the panel is on the outside because such protusions might be prone to damage due to wear and tear and careless handling. In one embodiment, the display layer includes a graphical image of a musical instrument such as a piano, drum set, guitar, or any other musical instrument that can be visually depicted. In each of these embodiments users preferably activate the corresponding acoustics by pretending to play the instrument, e.g. by interacting with the keys of the piano, drumsticks of the drum set, and strings of the guitar. In a highly preferred embodiment all these musical instruments play the same song sequences so that if a plurality of users came together with say two guitars, drum set and a piano, they could actually coordinate the activation and play a real orchestrated song.

The embodiment of the interactive musical folder (IMF) 710, as shown in FIGS. 7A-7F, is comprised of two major elements: a folder 712 having at least one pocket which can consist of a three-hole notebook, a spiral notebook or the like, and an electronics circuit 776.

The folder 712, as shown in FIGS. 7A and 7B, comprises a front cover 714 consisting of an outer panel 716 and an inner panel 728, and a back cover 742 also consisting of an outer panel 744 and an inner panel 756.

As shown in FIG. 7A, the outer panel 716 of the front cover 714 has an outer surface 718, an inner surface 720, an outer edge 722 and an inner edge 724. Likewise, the inner panel 728 of the front cover 714 has an outer surface 732, an inner surface 730, an outer edge 734 and an inner edge 736. The inner edge 724 of the outer panel 716 is integral with the inner edge 736 of the inner panel 728. The inner panel 728 also has a switch slot 738 located adjacent the inner edge 736 of the inner panel 728, and four slots 740 that allow access to finger activated contacts A1-A4 as described herein. As also shown in FIG. 7A, the outer panel 744 of the book cover 742 has an outer surface 746, an inner surface 748, an outer edge 750 and an inner edge 752. Likewise, the inner panel 756 has an outer surface 760, an inner surface 758, an outer edge 762 and an inner edge 764. The inner edge 752 of the outer panel 744 is integral with the inner edge 764 of the inner panel 756.

To secure the inner edges 724, 736 of the front cover 714 and the inner edges 752, 764 of the back cover 742, a spine 768 is attached by means of an adhesive 770, as shown in FIGS. 7A and 7B. Alternatively, panels 744 and 716 may be contiguously formed a single material, such as plastic or cardboard with panels 728, 756 being attached thereto using an adhesive. Within the front cover 714 is located a loudspeaker, L1, and an ASIC. On the back cover 742 is located a battery, B1, and switch, S1. It should be appreciated that the electronics, B1, S1, ASIC, L1, and contacts A1-A4 can be incorporated onto any of the panel surfaces, provided that they are suitably protected from damage or exposure to the user. It should also be appreciated that to further enhance the utility of the IMF 710 a partial pocket 790 can be located on the outer surface 760 of the outer panel 756 and on the outer surface 732 of the inner panel 728. A side view of the IMF 710 is shown in FIG. 7B.

The electronics circuit, which is shown in an electrical wiring diagram in FIG. 7C and in a schematic diagram in FIG. 7F, is comprised of a first section 778 and a second section 780. The first section 778 is comprised of an integrated circuit (IC), a set of finger-activated contacts A1-A4 [not shown], and a loudspeaker L1. The second section 780 is comprised of a battery (B1) and a power switch S1.

The IC is comprised of an Application Specific Integrated Circuit (ASIC). The ASIC can be programmed to store at least one song or a series of tones stored within its memory. The ASIC, as shown in FIGS. 7C and 7F, has a first input (I1), a second input (I2), a third input (I3), a fourth input (I4), a first output (01) and a second output (02).

In the present embodiment, the set of finger-activated contacts are comprised of the four contacts A1, A3, A3 and A4. As shown in FIG. 7F, contact A1 is connected to contact A2, and contact B1 is connected to contact B2. The “A” contacts are connected to I1 of the ASIC, and the “B” contacts are connected to I2 of the ASIC. The four contacts A1-A4 protrude through the four slots 740 on the inner panel 728, as shown in FIGS. 7D and 7E. The four slots 740 can consist of elongated slots, as shown in FIG. 7D, or circular slots, as shown in FIG. 7E. The elongated slots are dimensioned to accept four wires that simulate guitar strings and the circular slots accept circular knobs.

The loudspeaker L1 is comprised of a flat piezo type speaker, which allows the speaker to be easily attached to the inner surface 720 of the panel 740 of the front cover 714, as shown in FIG. 7C. The second section 780 of the electronics circuit is located on the surface 760 of panel 756 of the back cover 742. The battery B1 is preferably a button-type battery and may consist of a set of batteries connected in series to provide the required voltage to operate the ASIC. The musical functionality of the present invention can be activated using a manual activation button [not shown] or the automatic activation mechanism described above and shown graphically as element 784 on FIG. 7C.

Folders with Back-Illuminated Designs

Yet another embodiment includes a back-illuminated picture formed in the display layer of a panel. The back illuminated picture comprises an image on a translucent material that is juxtaposed above a light source. The circuitry comprises an activation button and power source that, when activated, powers the light source which shines through and illuminates the translucent material having an image formed thereabove.

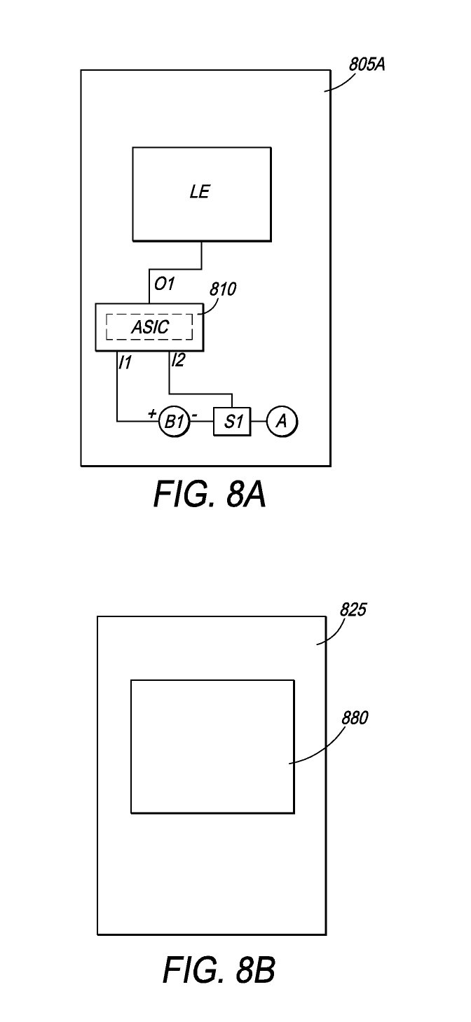

Referring to FIG. 8A, electronic circuitry and visual features defining one embodiment of the present invention are shown. In this exemplary embodiment, a plurality of electronics is provided in at least one of the front cover, back cover or divider panel 805A. The plurality of electronics are embedded in a layer within the front cover, back cover, or divider cover, as in layer 416A of FIG. 4A or layers 416B or 417B of FIG. 4B.

The electronics circuit is comprised of an integrated circuit (IC) 810, at least one light emitter (LE), a battery (B1), a power switch (S1), and an activation mechanism (A), such as a button, that provides the electrical contact to thereby switch the power on. The IC 810 is comprised of an Application Specific Integrated Circuit (ASIC). The ASIC can be programmed to transmit signals that cause the light emitter LE to emit light that back-illuminates a design incorporated into the display layer. The ASIC has at least two inputs and at least one output to the light emitter (LE).

Operationally, when a user activates the activation button A, it causes the switch S1 to transmit power, originating from the battery B1, to the ASIC which, in turn, is programmed to cause the light emitter (LE) to illuminate. It should be appreciated that the light emitter can be any type of light emission device provided that it can incorporated into a folder structure and is sufficiently safe to use. The battery B1 is preferably a button-type battery and may consist of a set of batteries connected in series to provide the required voltage to operate the ASIC.

Referring to FIG. 8B, a display layer 825 with a graphical design is shown. In one embodiment, the display layer 825 comprises a physical void covered by a translucent material 880 through which light, emitted from the light emitter (LE), can pass. The translucent material 880 can be in the form of any graphical design and be made of plastic, cellophane, or any other material that permits at least a portion of the light to pass from within the cover and through the material for viewing by a user.

Folders with Audio Capabilities

Another embodiment of the present invention incorporates a microphone such that a person can record a message or thought that gets stored on a suitable electronic memory device (such as RAM, ROM, PROM, EEPROM or any other suitable memory known in the art) when a corresponding ‘record’ switch is manually activated. The recorded message can then be played back via speaker by pressing a ‘play’ switch. It should be appreciated that this embodiment can be combined with, or integrated into, any of the embodiments described herein.

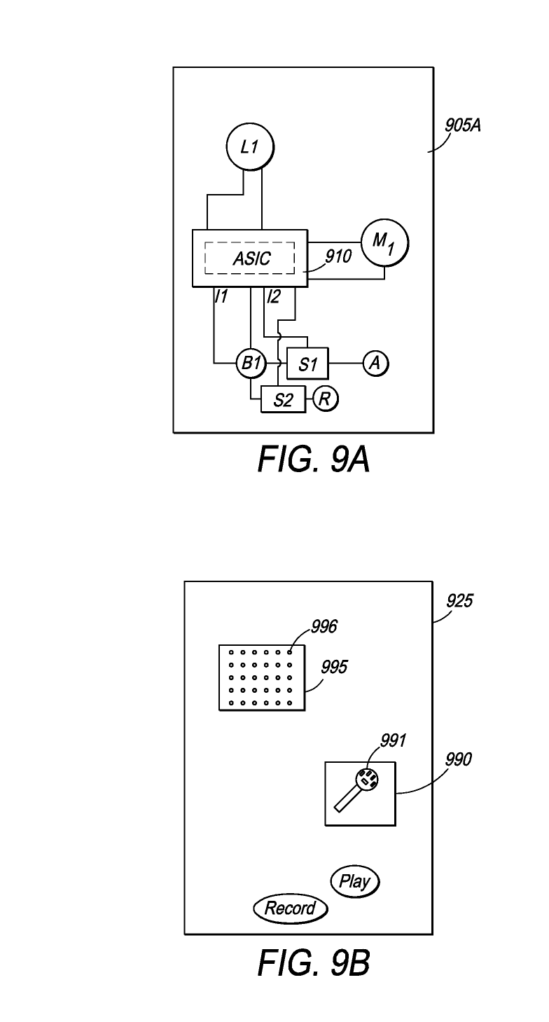

Referring to FIG. 9A, electronic circuitry and visual features defining one embodiment of the present invention are shown. In this exemplary embodiment, a plurality of electronics is provided in at least one of the front cover, back cover or divider panel 905. The plurality of electronics are embedded in a layer within the front cover, back cover, or divider cover, as in layer 416A of FIG. 4A or layers 416B or 417B of FIG. 4B.

The electronics circuit is comprised of an integrated circuit (IC) 910, at least one microphone, M1, at least one speaker, L1, a battery (B1), a first power switch (S1), an activation mechanism that initiates the recording of audio (R), a second power switch (S2), and an activation mechanism that initiates the playback of audio (P). The recording activation mechanism, R, and playback activation mechanism, P, can be a button that provides the electrical contact to thereby switch, via S1 or S2, the power on. The IC 910 is comprised of an Application Specific Integrated Circuit (ASIC). The ASIC can be programmed to transmit signals that cause the microphone, M1, to begin receiving audio, to save the received audio signals in a memory, and to playback stored audio signals through speaker L1. The ASIC has inputs in communication with a first switch, S1, that is activated by a playback mechanism, P, and inputs in communication with a second switch, S2, that is activated by a record mechanism, R. The ASIC has outputs in communication with microphone, M1, and speaker, L1.

Operationally, when a user activates the record activation button R, it causes the switch S2 to transmit power, originating from the battery B1, to the ASIC which, in turn, is programmed to cause the microphone, M1, to receive audio signals and transmit the signals to the ASIC for storage on a memory device preferably located on the IC 910. When a user activates the playback activation button P, it causes the switch S1 to transmit power, originating from the battery B1, to the ASIC which, in turn, is programmed to cause the memory device to transmit stored audio signals to speaker, L1, which then plays the stored audio. It should be appreciated that the microphone and speaker can be any type of microphone or speaker provided that it can incorporated into a folder structure and is sufficiently safe to use. The battery B1 is preferably a button-type battery and may consist of a set of batteries connected in series to provide the required voltage to operate the ASIC.

Referring to FIG. 9B, a display layer 925 with graphical designs is shown. In one embodiment, the display layer 925 comprises a speaker image 995 having a plurality of holes 996 through which audio can be transmitted from a speaker without muffling or interference by a display layer 925 structure. Additionally, the display layer 925 comprises a microphone image 990 having a plurality of holes 991 through which audio can be transmitted from a user to the microphone without muffling or interference by a display layer 925 structure.

Although the present invention has been particularly shown and described above with reference to five specific embodiments, it is anticipated that alterations and modifications thereof will no doubt become apparent to those skilled in the art. In particular, it should be appreciated that the individual design elements of each of the embodiments described herein can be mixed and matched, combined, or integrated in any manner to achieve a desired user experience. It is therefore intended that the following claims be interpreted as covering all such alterations and modifications as fall within the true spirit and scope of the invention.

We claim:

1. A folder having at least one pocket comprising:
a. A first cover having a front panel and a back panel;
b. A second cover having a front panel and a back panel wherein the second cover is physically attached to the first cover;
c. A display layer physically incorporated into the front panel of the first cover through which a plurality of LEDs can be viewed;
d. An activation mechanism physically incorporated into at least one of the front or back panel of said first cover or second cover;
e. Circuitry that places in electrical communication a power source, the activation button and said LEDs; and
f. A substrate in physical contact with said circuitry for providing protection to the circuitry.

2. The folder of claim 1 wherein the LEDs flash randomly.

3. The folder of claim 1 wherein the LEDs flash in a predetermined pattern.

4. The folder of claim 1 wherein the LEDs are positioned in proximity to textual statements placed on a surface of the display layer.

5. The folder of claim 4 wherein the textual statements include at least one of could, may be, yes, ask again, always, and no.

6. The folder of claim 1 further comprising a microphone for recording sound.

7. The folder of claim 1 further comprising a speaker for playing sound.

8. A folder having at least one pocket comprising:
a. A first cover having a front panel and a back panel;
b. A second cover having a front panel and a back panel wherein the second cover is physically attached to the first cover;
c. A display layer physically incorporated into the front panel of the first cover wherein the display layer has a plurality of holes;
d. An activation mechanism physically incorporated into at least one of the front or back panel of said first cover or second cover;
e. Circuitry that places in electrical communication a power source, a memory, the activation mechanism and said speaker; and
f. A substrate in physical contact with said circuitry for providing protection to the circuitry.

9. The folder of claim 8 wherein the activation mechanism is in the form of a graphical image of a piano key.

10. The folder of claim 8 wherein the activation mechanism is in the form of guitar strings protruding from a surface of the display layer.

11. The folder of claim 8 wherein the activation mechanism is in the form of a graphical image of a drumstick.

12. The folder of claim 8 wherein the activation mechanism is in the form of a display layer having a graphical image of a drum.

13. The folder of claim 8 further comprising a microphone for recording sound.

14. The folder of claim 8 further comprising a speaker for playing sound.

15. A folder having at least one pocket comprising:
a. A first cover having a front panel and a back panel;
b. A second cover having a front panel and a back panel wherein the second cover is physically attached to the first cover;
c. A display layer physically incorporated into the front panel of the first cover;
d. An activation mechanism physically incorporated into at least one of the front or back panel of said first cover or second cover;
e. A plurality of gears physically incorporated into the first cover;
f. A movable structure positioned above the display layer and physically attached to at least one of said gears;
g. Circuitry that places in electrical communication a power source, the activation mechanism and said plurality of gears; and
h. A substrate in physical contact with said circuitry for providing protection to the circuitry.

16. The folder of claim 15 wherein the movable structure is a rotating wheel.

17. The folder of claim 15 wherein the movable structure is hands of a clock.

18. The folder of claim 1 further comprising a microphone for recording sound.

19. The folder of claim 1 further comprising a speaker for playing sound.

20. A folder having at least one pocket comprising:
a. A first cover having a front panel and a back panel;
b. A second cover having a front panel and a back panel wherein the second cover is physically attached to the first cover;
c. A display layer physically incorporated into the front panel of the first cover wherein the display layer has embedded therein translucent material;
d. An activation mechanism physically incorporated into at least one of the front or back panel of said first cover or second cover;
e. Circuitry that places in electrical communication a power source, the activation button and a light emitter wherein said light emitter is positioned below said translucent material; and
f. A substrate in physical contact with said circuitry for providing protection to the circuitry.
